(19) United States
(12) Patent Application Publication
(10) Pub. No.: US 2002/0052819 A1
(43) Pub. Date: May 2, 2002

(54) Financial instruments

(76) Inventor: Peter Geoffrey Burton, New South Wales (AU)

Correspondence Address: ABELMAN, FRAYNE & SCHWAB, 150 East 42nd Street, New York, NY, 10017, US

(21) Appl. No.: 09/938,766

(22) Filed: Aug. 24, 2001

(30) Foreign Application Priority Data
Aug. 24, 2000 (AU) PQ 9601

(51) Int. Cl. G06F 17/60

(52) U.S. Cl. 705/36

(57) ABSTRACT

The invention provides new forms of financial instruments and methods for generating or issuing them. A company replaces some of its held or recuperated conventional stock with synthetic capital stock, or equity stock which has no dividend or franking credit. Some or all of the dividend stream or franking credits associated with the recuperated or held stocks are diverted to an issuer of medium term convertible notes. The issuer of the notes uses the diverted streams of dividends or franking credits to boost the yield of the notes and for other purposes.

### TECHNICAL FIELD

The invention pertains to financial instruments and more particularly to a new financial instrument in the form of a medium term convertible note which is associated with an enhanced coupon or dividend rate. The invention comprises this new form of financial instrument as well as method for issuing it.

### BACKGROUND ART

Global funds managers discriminate between candidates for investment on many grounds. Fundamental qualities sought are good management, a business model struck on some sustainable source of competitive advantage, formalisation of intellectual property and human capital management programs, a strong balance sheet and market power.

Established companies which are globally recognised as investment grade invariably have strong operating cashflows (e.g. telephone companies and large pharmaceutical companies). Smaller companies with strong intellectual property positions may become accepted as investment grade on the basis of expectation of strong future cashflows.

These two are linked by the increasing need for the established older economy corporations to purchase business development products and services as they become packaged by smaller, more innovative and entrepreneurial companies. This link means that valuations of emerging technology-based companies are more often than not determined by the corporate needs of one of the ageing elite for “pipeline” product. than by the intrinsic value of their own discounted future cashflows.

Even investment grade companies have become increasingly volatile investments over the last decade as the operation of highly leveraged hedge funds increasingly impact the market, while democratisation of trading through the internet has amplified short-term momentum trading.

Traditionally investors are clustered into two simple groups: “bonds” or fixed interest investors and “equities” investors. More recently the emergence of the hedge funds has emphasised the role of derivative financial products. Derivative trading strategies, for extending leverage or for acquiring protection against adverse market moves, are increasingly routine.

Bonds investors, traditionally conservative, have seen volatility encroach onto their market just as the issuance of bonds from government issuers is drying up.

Equities investors, fighting traditional volatility and increasingly oriented to capital appreciation where gains are taxed at reduced levels, seek the goals of steep capital appreciation and low volatility.

As companies become global operators, paying tax on earnings in many jurisdictions, the complexities of fully franked dividends have increased despite their fundamental attraction to high payee-tax-paying investors.

The stock of a company serves a multiplicity of purposes. It is the vehicle for raising external capital, the abacus for titrating control of the corporation, and the means by which good management performance can be rewarded. It is also the means by which dividend streams can be apportioned amongst owners, and capital returned or raised through the offer of buybacks or rights issues respectively.

Stock is augmented by debenture issues for the more capital hungry, where an interest coupon offered at a premium to the bond market stimulates interest in convertible note offerings. Strong cashflows on the other hand support preferred debentures which minimise ownership dilution.

Strongly performing corporations have traditionally been rated on their earnings yield (EY) and price to earnings ratio (PE), although more recently capital is being managed with no investor expectation of regular dividends in order to maximise capital appreciation of the stock.

The prominent feature of such “technology” stocks is their volatility, as derivatives products enable hedge funds to powerfully lever short-term positions.

This, coupled with powerful cashflows into mutual funds whose managers must put the capital to work at the end of the market most leveraged to market performance, has seen the emergence of high PEs and Price to Revenue multiples.

Individuals and increasingly even the better informed professional and institutional investor, are losing confidence to invest in companies which should be good investments: their stock price is just too high relative to earnings and short-term volatility makes holding the stock hard to justify.

### DISCLOSURE OF THE INVENTION

Provided that a strongly positioned technology company enjoys the prospect of being accorded a reasonable credit rating (i.e. it has an outlook for strong and sustainable cashflows), then the opportunity arises to synthesise three new classes of investment instruments out of features traditional bound together in the conventional stock of that company.

Accordingly the invention provides a method of issuing a financial instrument comprising, for an issuer of such instrument, the steps of acquiring or holding a significant minority of a target company's conventional stock, entering into an arrangement with a target company which results in an allocation of a dividend stream to the Issuer, the Issuer then issuing medium term convertible notes which are associated with a coupon or dividend rate in excess of that offered on the conventional stock.

The invention also provides a method of issuing a financial instrument comprising, for a target company, offering new equity stocks which do not pay a dividend for shares of that company's conventional stock, then by arrangement with an issuer of medium term notes, allocating some or all of the dividend stream of the acquired conventional stock to the issuer.

### MODES FOR CARRYING OUT THE INVENTION

The invention proposes a new financial instrument, the high yield medium term note or MTN. An institution wishing to issue MTNs (“Issuer”) first identifies a target company requiring investment and having the potential for strong and sustainable cash flow. In general, a target company will not have a demonstrated past performance in generating strong and systematic cash flows. Companies are considered particularly eligible where their earnings are changing in quality, volume or sustainability. These changes may be brought about by the implementation of a new business model, the obtaining of new intellectual property such as patents or the acquisition of new market power for any one of a variety of reasons.

The process continues by quarantining a significant minority of the company in the hands of the Issuer. By “significant minority” it is envisaged that 5-20% of the company's stock will be owned by the Issuer, e.g. a bank or other financial institution that is licensed to deal in securities and which can on its own terms issue debt (debenture) instruments secured against the pool of quarantined stock.

Next, the Issuer and the company enter into a contractual scheme or arrangement to reorganise the capital of the company so that a significant portion to the company's conventional stock gets replaced by the equivalent number of new shares issued by the target company. The new shares, deemed synthetic capital™ stocks are equity instruments which pay no dividends. A company's conventional shares for this purpose may be acquired from the public through a buyback or by exchanging the new synthetic capital shares for conventional dividend paying shares currently held by the company's shareholders.

In accordance with the contractual arrangements between the Issuer and the company, some or all of the dividend stream and franking credits associated with the conventional stock recuperated by the target company and now held by it are allocated to the Issuer so that the Issuer can enhance the medium term convertible notes with an enhanced yield. Attracted by a credit-rating for the notes and a high yield, bonds investors, traditionally countercyclical investors to equities investors, would be offered the company's MTNs by the MTN Issuer, which could be structured into national parcels to deliver locally derived taxation benefits (such as franking of dividends) to investors in that location.

Importantly, the pool of stock against which the MTNs were held could act as a buffer to underlying stock volatility, by the operation of a buyback—for reissue in the form of MTNs—from the open stock pool in any period of price weakness (from oversupply of equity stock).

The Issuer may issue MTNs in packages suitable to bond buyers, for example in lots of $50,000. The convertible notes are secured by the Issuer's pool of conventional stock. Because the ratio of the conventional stock dividends held or controlled by the Issuer inclusive of those allocated to it by arrangement is in excess of the value of the coupons on the convertible notes issued by it, it may offer franked dividends or coupons which represent some multiple of the normal dividend offered by the company. For example, if the Issuer holds 10% of the company's stock and acquires or controls an additional 50% of the conventional stock (by the arrangement) then the Issuer has the potential to offer a coupon or dividend up to six times the conventional dividend and franking benefits conferred by the conventional stock.

In preferred embodiments of the invention, the Issuer does not pay the maximum dividend on the notes. In order to succeed it must offer a competitive dividend rate, but preferably utilises the extra dividend income to generate professional fees for itself, purchase insurance on its capital portfolio and develop and pool of cash against which warrants and options can be risked for the purpose of forming a buffer to stabilise the price of the underlying stock of the company.

The issuer of the MTNs, assured of access to the whole of the company's dividend stream and first access to any ranking benefits, could synthesise cost-effective capital market insurance products against any adverse price movement in the pool of equity stock held in quarantine, and take a management fee from that stream before passing on the dividends to the MTN holders in each jurisdiction.

The holder of the quarantined portion of the company's stock could choose to price the issue of put and call options and warrants such that speculators and hedge funds would be attracted to take positions out of synchrony with the current volatility in the underlying stock. That is during periods of sharp escalation in the share price, more puts could be sold, while during periods of sharp decline in the company's share price more calls than puts could be sold, at least in principle.

As writing these options could always be fully covered, aggressive positions cold be synthesised for sale against the immediate trend in the market for the company stock, regardless of whether the underlying driver for this volatility were the company's own perceived prospective performance or some external market influence.

This form of stock, from which both dividend complexity and price volatility has been systematically exported, is designed to be of maximum appeal to index fund investors with an orientation towards capital gains.

Lowered capital-gains tax rates for emerging companies (US, UK, AUS, etc) could spur this interest for our emerging technology companies.

The combination of steady capital appreciation (supported by a continuous flexible buy-back program by the MTN issuer), and uncharacteristically low price volatility, is—we believe—likely to result in increased interest in the synthetic capital stock from a wide pool of investors attracted by the low risk-return characteristics built into the SCS version of the company stock, who might not otherwise be attracted to hold a normally volatile “technology” stock.

Increased attention to the special features of the company for which an SCS product set were offered, could well see the stock well bid up from an international canvas of investors, as opposed to the locally proximal investor pool who might have more direct knowledge of the company's prospects.

Special buying interest in companies branded by the SCS cache would support management of those companies in their own endeavour to acquire for scrip other privately or publicly companies which strengthened either (i) the product or service offerings or the company, or (ii) its geographic footprint.

The scheme or arrangement between the Issuer and the company requires that the equities repurchased by the company from its shareholders and held by the company and that the dividend income from those stocks be channelled to the Issuer according to a strategic plan jointly agreed between the company and the Issuer. Accordingly, the arrangement takes into consideration the Issuer's costs inclusive of fees, insurance and cash requirements.

Some of aforementioned principles are illustrated in Table 1.

FIG. 1 contains two columns. In the first column a company's capitalisation is illustrated in relation to its trading performance. We have taken an example of the company trading with $200,000,000 of revenue, $10,000,000 of earnings before interest and tax and $5,000.000 after tax profit. On a typical company dividend payout ratio of 60% that would correspond to $3,000,000 of the profit after tax being paid out to shareholders as a dividend.

Lets imagine in this illustration that the same company has 10,000,000 issued shares and each of these is valued by the market at this point in time at $10. This corresponds to the way the market is capitalising the company. The company is capitalised at about half the revenue or about 20 times normal profit after tax which means the market is paying for 20 years of normal profit after tax in the absence of growth.

First, a bank or other institution buys 10% of the company's equity and pays the full price of $10 to buy 10% of the shares or 1,000,000 shares, so 1,000,000 shares have been removed from the equities market. There are now only 9,000,000 shares left, 90% of the original equity. The investment bank holds 1,000,000 shares and against that capital asset writes a new instrument called a segmented note to which it applies the contracted yield and in this case the dividends is agreed to be $1.80. This dividend was 30 cents originally, as shown in column 1.

The bank or institution pays $10,000,000 to buy 1,000,000 shares on the market to form a new issue. They agree with the company that they will be privileged to obtain all of the normal dividend payout to be directed to a new form of convertible notes which are written on the back of the shares which are held by the bank. If there were 1,000,000 shares there can be 1,000,000 notes, because they will be convertible one to one. Because there is only 1,000,000 notes and there are $3,000,000 of diverted dividends one could in principle apply $3 of dividend to each of these new notes, but that would constitute a 30% yield which is so high as to be unnecessary. Instead one might apply a proportion—lets say $1.80 to each of the notes which would constitute a nominal yield relative to the costs of 18%. It is proposed that the market will bid up the value of these notes to a higher value to normalise on a yield that is typical for the investment market, such as a 10% yield.

Lets say that the notes therefore find a market equilibrium value amongst note holders at a 10% yield which would value the notes at the equivalent per share of $18. By attracting note holders to take a position in the company that previously only had equity, 1,000,000 shares that were originally valued at 10,000,000 have now become valued as notes at $18,000,000. This has required the use of $1.80 or 60% of the $3 of dividend which leaves $1.20 left over of the annual dividend which can be applied to the bank's holding costs of the foundation 1,000,000 shares against which the notes are written. Therefore the bank holding 1,000,000 shares has an attractive 12% yield on its funds. This is an attractive proposition to the bank and an attractive proposition to the note holders.

In light of the above, the equities market players are left to bid for less of the stock, in fact 90% of the stock. Accordingly, they will be prepared to bid more because buyer demand will drive up the price. In principle, the same amount of equity interest should apply to the stock except it will be compressed into a smaller number of shares. If the same number of people, (the same weight of buying) that represented $100,000,000 were to be applied to the now 9,000,000 shares available, the equilibrium pricing would be $11.10, rather than the original $10.

By broadening the market by constructing a new form of instrument one obtains a very high value on the small segment that we have especially constructed but without incurring a cost on the pricing of the balance of the equities. In fact one has driven up the price of the equities by compressing the markets, making the stock harder to acquire which means that it will be bid up in price. By construction and manipulation of stock, one can create an even higher demand from equity holders, despite the fact that the equities have had dividends removed. When there are an excess of sellers in the equities market one can divert stock into the bond market and when there are an excess of buyers in the equities market one may supply stock back from the bond market. Thus, this new form of issue creates a buffer. This buffer removes the unwanted ebbs and flows of supply and demand. In this way, a stock is transformed from a very volatile stock into a less volatile stock by active use of this buffer; buying notes back, either putting them back into shares or consuming shares and converting them into notes to a different market. By removing volatility (which is seen as a risk to stock) the segmented capital shares become even more attractive. In Column 2, the example provides a share price of $13.00, leading to a market capitalisation of $131 million.

TABLE 1

| Column 1 | | | Column 2 | | |
|---|---|---|---|---|---|
| Ordinary | Capitalisation | | Segmented Capital | Capitalisation | |
| Shares | $100 | million | Stock | $131 | million |
| Ordinary | 10 | million | Segmented Capital | 9.0 | million |
| Shares | | | | | |
| $ per Share | $10 | | $ per Share | $13 | |
| | | | Scarcity 2.0 | | |
| Revenue | $200 | million | Revenue | $200 | million |
| EBIT | $10 | million | EBIT | $10 | million |
| NPAT | $5 | million | NPAT | $5 | million |
| Payout % | 60% | | Payout % | 0% | |
| Div Yield | 3.0% | | Div Yield | 0.0% | |
| | | | Segmented Notes | 1.0 | million |
| | | | $ per Note 10 | $18 | 10% yield |
| | | | Revenue | $200 | million |
| | | | EBIT | $10 | million |
| | | | NPAT | $5 | millon |
| | | | Payout % | 60% | |
| | | | Div p.a.* | $1.80 | |
| | | | Stockbank | | |
| | | | *less fees | $1.20 | m |
| | | | Capital Cost | $10.0 | |
| | | | Div Yield % | 12.0% | p.a. |

What is claimed is:

1. For an issuer, a method of issuance of a convertible note, comprising the steps of:
acquiring or holding a significant minority of a target company's conventional stock;
entering into an arrangement with the target company which results in an allocation of a dividend stream to the issuer;
issuing medium term convertible notes which are associated with an enhanced coupon or dividend rate.

2. The method of claim 1, wherein:
the significant minority is 5-20%.

3. The method of claim 1, wherein:
the arrangement requires the company to reorganise its capital so that a significant portion of the target company's convention stock gets recuperated and replaced by an equivalent number of new shares issued by the target company;
the new shares not paying any dividend.

4. The method of claim 3, wherein:
the arrangement requires the target company to divert a dividend stream or a franking credit associated with the recuperated stock to the issuer.

5. The method of claim 4, wherein:
the issuer enhances the notes with a portion of the diverted dividend stream or franking credit.

6. The method of claim 5, wherein:
the issuer offers a competitive dividend rate or franking credit on the notes and also uses the diverted dividend stream or franking credit to generate professional fees for itself, or purchase insurance on its capital portfolio or to develop a pool of cash against which warrants and options can be risked for the purpose of forming a stock price buffer.

7. The method of claim 1, wherein:
the issuer prices put and call options or warrants such that speculators and hedge funds would be attracted to take positions out of synchrony with a current volatility in the underlying stock.

8. For a company having conventional stock, a method of issuing synthetic capital stock, comprising the steps of:
recuperating or holding a portion of its convention stock;
entering into an arrangement with an issuer of notes whereby the dividend stream or franking credits of the recuperated or held portion is diverted to the issuer;
the company then issuing synthetic capital stock to replace the recuperated or held portion, the synthetic capital stock not having any associated dividend or franking credits.

9. The method of claim 8, wherein:
the arrangement requires the issuer to issue convertible medium term notes having enhanced dividend or franking credit notes.

10. The method of claim 1, wherein:
the number of shares in the significant minority is equal to the number of convertible notes.
